(19) United States
(12) Patent Application Publication
(10) Pub. No.: US 2026/0063885 A1
(43) Pub. Date: Mar. 5, 2026

(54) Micro-Raman Apparatus and Method for Controlling Micro- Raman Apparatus

(71) Applicant: SHIMADZU CORPORATION, Kyoto-shi (JP)

(72) Inventors: Tetsuro FURUTA, Kyoto-shi (JP); Naoya FUJIWARA, Kyoto-shi (JP); Yuka MORITANI, Kyoto-shi (JP)

(21) Appl. No.: 19/124,361

(22) PCT Filed: Oct. 6, 2023
(86) PCT No.: PCT/JP2023/036490

§ 371 Date: Apr. 25, 2025

(30) Foreign Application Priority Data
Oct. 28, 2022 (JP) 2022-173233

(51) Int. Cl. G02B 21/26; G01J 3/44; G01N 21/65; G02B 21/06

(52) U.S. Cl. CPC G02B 21/26; G01J 3/4412; G01N 21/65; G02B 21/06; G01N 2201/0221; G01N 2201/06113; G01N 2201/0638; G01N 2201/1273

(57) ABSTRACT

A micro-Raman apparatus (100) includes a light source unit (110), an objective lens unit (140), a detection device (160), a drive device (180), and a controller (200) for controlling the drive device (180). The light source unit (110) includes a plurality of light source devices (111 to 114) configured to emit lights of different wavelengths from one another. The objective lens unit (140) collects light from the light source unit (110) and irradiates a sample (SMP) to be analyzed with the light. The detection device (160) detects Raman-scattered light emitted from the sample (SMP). The drive device (180) changes a relative distance between the sample (SMP) and the objective lens unit (140). The controller (200) is configured to correct the relative distance in accordance with a wavelength of light emitted from a light source device to be used.

### TECHNICAL FIELD

The present disclosure relates to a micro-Raman apparatus and a method for controlling a micro-Raman apparatus, and more specifically to focus adjustment control in a micro-Raman apparatus.

### BACKGROUND ART

Japanese Patent Laying-Open No. 2021-117022 (PTL 1) discloses a micro-Raman spectrometer (hereinafter also referred to as a “micro-Raman apparatus”). The micro-Raman apparatus described in PTL 1 includes an excitation laser light source and a spectroscopic detector. In the micro-Raman apparatus of PTL 1, the laser light source irradiates a sample with a laser beam to cause emission of Raman-scattered light from the sample. The emitted Raman-scattered light is dispersed by the spectroscopic detector, and the intensity distribution of the dispersed Raman-scattered light is detected, whereby, for example, components in the sample are analyzed.

### CITATION LIST

### Patent Literature

PTL 1: Japanese Patent Laying-Open No. 2021-117022

### SUMMARY OF INVENTION

### Technical Problem

A micro-Raman apparatus generally employs a configuration that combines an optical microscope with a Raman spectroscopic device. In such a configuration, a visible light source for use in the optical microscope and a laser light source for use in the Raman spectroscopic device are used in the same optical system. Some micro-Raman apparatuses include a plurality of laser light sources of different wavelengths from one another, and are configured to switch between/among these laser light sources to conduct an analysis.

In a micro-Raman apparatus, light emitted from a light source is collected by an objective lens and directed to a sample. For a micro-Raman apparatus that uses a plurality of light sources in the same optical system as described above, a light collection position of the objective lens changes due to a relative difference in wavelength between lights from the light sources. It is thus required to adjust a focal length (i.e., focus) between the objective lens and the sample each time the light sources are switched.

If such adjustment is performed each time the light sources are switched, the adjustment will take time, resulting in an increased burden on an operator. In addition, since the focus adjustment of a laser light source requires experience and skill, manually performing the focus adjustment may cause measurement results to vary depending on the operator who performs the adjustment.

Furthermore, since the height from a stage is different for each object to be measured, and automatic adjustment of the focal length requires computing processing based on captured images, the automatic adjustment of the focal length is challenging in itself.

The present disclosure has been made to solve the above-described problem, and an object of the present disclosure is to facilitate focus adjustment associated with switching of light sources and to reduce variations in measurement results in a micro-Raman apparatus including a plurality of light source devices.

### Solution to Problem

A micro-Raman apparatus according to an aspect of the present disclosure includes a light source unit, an objective lens unit, a detection device, a drive device, and a controller for controlling the drive device. The light source unit includes a plurality of light source devices configured to emit lights of different wavelengths from one another. The objective lens unit collects light from the light source unit and irradiates a sample to be analyzed with the light. The detection device detects Raman-scattered light emitted from the sample. The drive device changes a relative distance between the sample and the objective lens unit. The controller is configured to correct the relative distance in accordance with a wavelength of light emitted from a light source device to be used.

A method for controlling a micro-Raman apparatus according to another aspect of the present disclosure relates to a method for controlling a micro-Raman apparatus including a light source unit, an objective lens unit, a detection device, and a drive device. The light source unit includes a plurality of light source devices configured to emit lights of different wavelengths from one another. The objective lens unit collects light from the light source unit and irradiates a sample to be analyzed with the light, The detection device detects Raman-scattered light emitted from the sample. The drive device changes a relative distance between the sample and the objective lens unit. The method includes: (a) obtaining information about the plurality of light source devices; (b) computing a correction value of the relative distance in accordance with a wavelength of light emitted from a light source device to be used; and (c) driving the drive device based on the correction value to change the relative distance.

### Advantageous Effects of Invention

In the micro-Raman apparatus according to the present disclosure, focus adjustment associated with switching of light source devices can be facilitated, and variations in measurement results can be reduced, in a configuration including a plurality of light source devices.

### BRIEF DESCRIPTION OF DRAWINGS

FIG. 1 is a schematic diagram showing the configuration of a micro-Raman apparatus in a first embodiment.

FIG. 2 is a diagram showing an example of the configuration of a light source device in the first embodiment.

FIG. 3 is a diagram for illustrating an overview of focus correction control in the first embodiment.

FIG. 4 is a diagram showing an example of information stored in a storage device in the first embodiment.

FIG. 5 is a diagram for illustrating correction of a drive range of a stage associated with the focus correction control.

FIG. 6 is a flowchart showing details of the focus correction control in the first embodiment.

FIG. 7 is a diagram showing the configuration of a micro-Raman apparatus in a second embodiment.

FIG. 8 is a diagram for illustrating an overview of focus correction control in the second embodiment.

FIG. 9 is a diagram showing an example of information stored in the storage device in the second embodiment.

FIG. 10 is a flowchart showing details of the focus correction control in the second embodiment.

### DESCRIPTION OF EMBODIMENTS

Embodiments of the present disclosure will be hereinafter described in detail with reference to the drawings. The same or corresponding parts in the drawings are denoted by the same reference characters and the description thereof will not be repeated.

### First Embodiment

### Configuration of Micro-Raman Apparatus

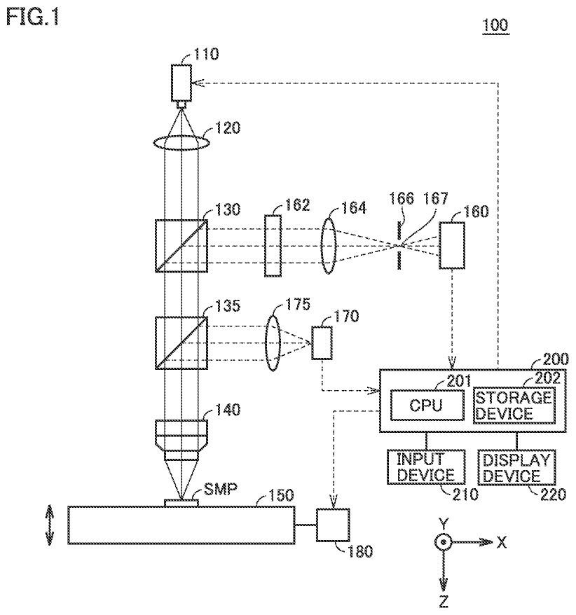

FIG. 1 is a schematic diagram showing the configuration of a micro-Raman apparatus 100 according to a first embodiment. Referring to FIG. 1, micro-Raman apparatus 100 includes, as the configuration of an optical system, a light source unit 110, a collimator lens 120, beam splitters 130 and 135, an objective lens unit 140, a stage 150 on which a sample SMP is placed, a detection device 160, a filter 162, condenser lenses 164 and 175, a slit 166, an imaging device 170, and a drive device 180. Micro-Raman apparatus 100 further includes a controller 200 for comprehensively controlling the entire apparatus. In FIG. 1, a placement surface of stage 150 is defined as the X-Y plane, and a normal direction to the placement surface is defined as the Z-axis direction.

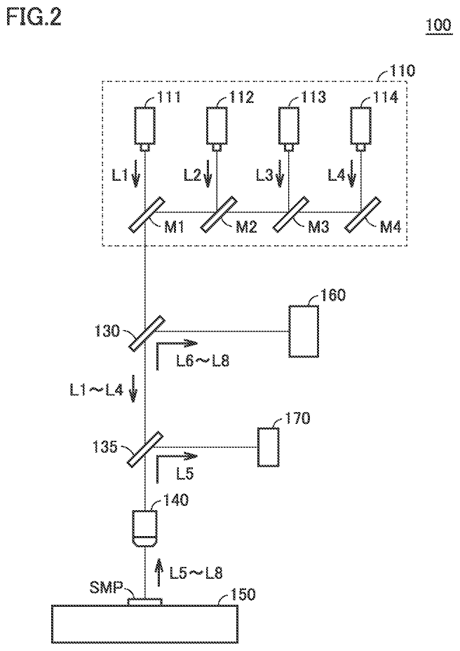

Light source unit 110 includes a plurality of light source devices, as will be described later in FIG. 2. A visible light source, a laser light source, an infrared light source, and/or an ultraviolet light source can be used, for example, as the plurality of light source devices.

Light emitted from light source unit 110 is substantially collimated by collimator lens 120 and guided in a positive direction along the Z-axis in FIG. 1. After passing through collimator lens 120, the light further passes through beam splitters 130 and 135 and enters objective lens unit 140. The light is collected in objective lens unit 140 and directed to sample SMP placed on stage 150.

When the light source device is a visible light source, light reflected by sample SMP passes through objective lens unit 140 and is reflected by a reflection surface of beam splitter 135. The light is then collected by condenser lens 175 and directed to imaging device 170. Imaging device 170 is a CCD camera, for example. An image of sample SMP captured by imaging device 170 is output to controller 200. In this case, micro-Raman apparatus 100 functions as an optical microscope.

When the light source device is a laser light source, sample SMP is irradiated with laser light to cause emission of Raman-scattered light in accordance with the irradiation laser light from sample SMP. The emitted Raman-scattered light passes through beam splitter 135 and is reflected by a reflection surface of beam splitter 130. The Raman-scattered light reflected by beam splitter 130 enters filter 162. In this case, micro-Raman apparatus 100 functions as a Raman spectroscopic device.

Filter 162 is a long pass filter, which is an optical filter that transmits light of longer wavelengths and blocks light of shorter wavelengths. Filter 162 has a cutoff wavelength that is shifted to be slightly longer than the wavelength of the laser light (irradiation light) emitted from the light source device. Thus, filter 162 blocks reflected light from sample SMP and Raman-scattered light (anti-Stokes light) of a shorter wavelength than the irradiation light, and transmits Raman-scattered light (Stokes light) of a longer wavelength than the irradiation light. When a plurality of laser light sources of different wavelengths are used, filters suitable for the respective laser light sources are selectively used.

After passing through filter 162, the Raman-scattered light is collected by condenser lens 164. An aperture (slit) 166 with a minute opening (pinhole) is disposed at a light collection point 167 for the Raman-scattered light. After passing through the pinhole in aperture 166, the Raman-scattered light enters detection device 160.

Detection device 160 is provided with a spectroscope, and a line sensor for detecting the intensity of dispersed scattered light, although neither is shown. The spectroscope is typically a grating. A CCD detector is used, for example, as the line sensor. The intensity of the dispersed light detected by detection device 160 is output to controller 200.

When an infrared light source or an ultraviolet light source is used as the light source device, reflected light from sample SMP is dispersed and measured by detection device 160, and substances in sample SMP are identified from light absorption by sample SMP.

Controller 200 includes a CPU 201 serving as a computing device, and a storage device 202. Storage device 202 includes a nonvolatile memory or a volatile memory such as a read only memory (ROM) or a random access memory (RAM), and/or a mass storage device such as a hard disc drive (HDD) or a solid state drive (SSD). CPU 201 reads a program and data stored in storage device 202, and comprehensively controls micro-Raman apparatus 100.

An input device 210 and a display device 220 are connected to controller 200. Input device 210 is, for example, a keyboard, a mouse, a pointing device, or a touch panel, and accepts an operation from a user. Display device 220 is, for example, a liquid crystal display (LCD) or an organic electro luminescence (EL) display, and displays the image of sample SMP captured by imaging device 170, the intensity distribution of the Raman-scattered light detected by detection device 160, an operating state of the apparatus, and the like.

Stage 150 is configured to be movable in the X-axis direction, the Y-axis direction and the Z-axis direction by drive device 180 operated by a command from controller 200. Moving stage 150 in the X-axis direction and/or the Y-axis direction allows for changing a measurement position in sample SMP. Moving stage 150 in the Z-axis direction allows for changing a relative distance between objective lens unit 140 and sample SMP to adjust focus of objective lens unit 140. The change of the measurement position and the adjustment of focus may be performed by moving the optical system including objective lens unit 140, instead of by moving stage 150.

FIG. 2 is a diagram for illustrating an example of the configuration of light source unit 110 in micro-Raman apparatus 100 in the first embodiment. In the example of FIG. 2, light source unit 110 includes: a plurality of light source devices having a visible light source 111, laser light sources 112 and 113, and an infrared light source 114; and mirrors M1 to M4. Laser light sources 112 and 113 have different wavelengths from one another.

Mirror M1 is located on an optical axis that connects visible light source 111 to objective lens unit 140. Mirror M1 transmits visible light L1 from visible light source 111 and reflects lights L2 to L4 from mirrors M2 to M4. Mirror M2 is located on an optical axis of laser light source 112, and reflects laser light L2 from laser light source 112 and transmits lights L3 and L4 from mirrors M3 and M4. Mirror M3 is located on an optical axis of laser light source 113, and reflects laser light L3 from laser light source 113 and transmits infrared light L4 from mirror M4. Mirror M4 is located on an optical axis of infrared light source 114, and reflects infrared light LA from infrared light source 114.

Visible light L1 that has passed through mirror M1, and laser lights L2 and L3 and infrared light L4 reflected by mirror M1 pass through beam splitters 130 and 135 and objective lens unit 140, and are directed to sample SMP.

Reflected light L5 from sample SMP for visible light L1 from visible light source 111 passes through objective lens unit 140 and, furthermore, is reflected by beam splitter 135 and enters imaging device 170. Raman-scattered lights L6 and L7 by laser lights L2 and L3 from laser light sources 112 and 113 pass through objective lens unit 140 and beam splitter 135, and are reflected by beam splitter 130 and enter detection device 160. Reflected light L8 from sample SMP for infrared light L4 from infrared light source 114 passes through objective lens unit 140 and beam splitter 135, and is reflected by beam splitter 130 and enters detection device 160.

Switching to each light source device may be done by switching between supply and cutoff of power to each light source device, or by opening/closing a shutter (not shown) disposed between each light source device and a corresponding mirror. The configuration of light source unit 110 shown in FIG. 2 is merely exemplary, and any configuration other than that shown in FIG. 2 may be used that allows switching between/among a plurality of light source devices.

### Description of Focus Correction Control

In micro-Raman apparatus 100 as described above, a plurality of light source devices such as a visible light source, a laser light source, an infrared light source, and/or an ultraviolet light source are used as light source unit 110 that illuminates sample SMP. Since the wavelengths of lights used in these different light source devices are different from one another, when a light source device to be used is switched, a light collection position of objective lens unit 140 (focal length) changes due to a relative difference in wavelength between lights from the light source devices. It is thus required to adjust the focal length between objective lens unit 140 and sample SMP (adjust focus) each time the light source devices are switched.

If such focus adjustment is performed each time the light sources are switched, the adjustment work will take time, resulting in a longer total wok time and an increased burden on an operator. In addition, since the use of a laser light source requires performing focus adjustment while observing a peak of the intensity of emitted Raman-scattered light, and the adjustment work requires experience and skill, manually performing the focus adjustment may cause measurement results to vary depending on the operator who performs the adjustment.

Furthermore, since the height from the stage is different for each object to be measured, and automatic adjustment of the focal length requires computing processing based on captured images, the automatic adjustment of the focal length is challenging in itself.

In the first embodiment, therefore, correction values corresponding to the relative wavelengths of the light source devices to be used are stored in the storage device in advance, and when the light sources are switched, focus correction control is performed to automatically adjust the focus in accordance with a correction value of a light source device to be used. By performing such focus correction control, the workload and the work time can be reduced, and the variations in measurement results can be reduced, as compared to when the focus adjustment is manually performed.

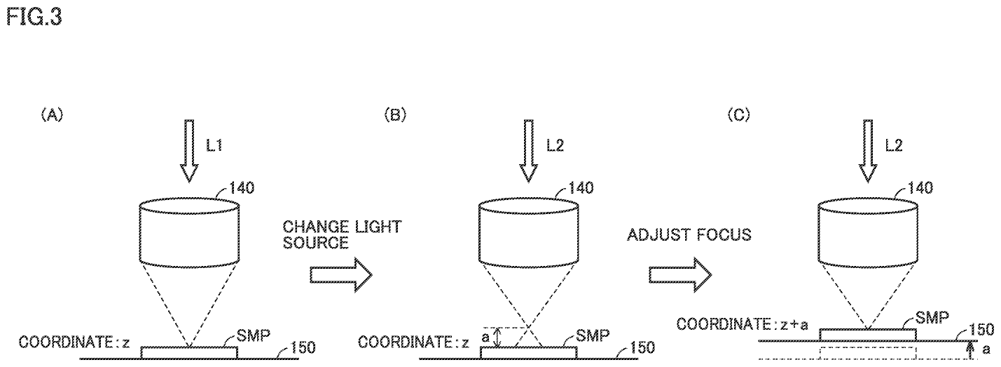

FIG. 3 is a diagram for illustrating an overview of the focus correction control in the first embodiment. The left diagram (A) in FIG. 3 shows a state after sample SMP is brought into focus when visible light source 111 is used. Stage 150 has a coordinate z at this time.

In the state of the left diagram (A), switching from visible light source 111 to laser light source 112 (the middle diagram (B)) causes the light collection position for laser light L2 by objective lens unit 140 to change from a position on sample SMP in the left diagram (A) to a position above and distant from this position by “a” due to the difference in wavelength between visible light L1 and laser light L2. That is, the sample falls out of focus.

As shown in the right diagram (C) in FIG. 3, storage device 202 stores in advance, an amount of correction corresponding to the amount of displacement “a” of the focus position of laser light L2 with respect to the focus position of visible light L1. When the light source device to be used is switched, controller 200 moves stage 150 to a position that takes into account the amount of correction (coordinate z+a).

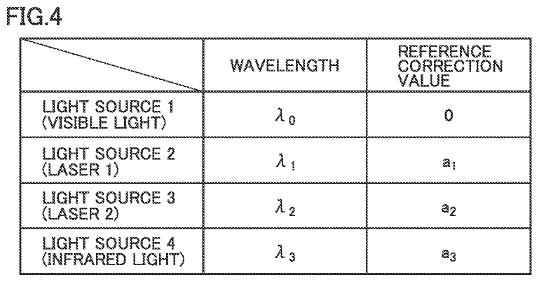

FIG. 4 is a diagram showing an example of information stored in storage device 202. In the example of FIG. 4, the information includes a wavelength of light emitted from each light source device, and a reference correction value of the focal position. Here, the reference correction value is, for example, the amount of displacement from a reference (correction value=0) that is the focal length when using visible light source 111 (light source 1) for each light source device. The correction value of each light source device may be set by a theoretical calculation based on the relative wavelength of each light source device, or may be set as the amount of displacement determined from an experimental adjustment using a reference sample and the like. Alternatively, only the wavelength of each light source device may be stored in storage device 202, and the correction value may be calculated, each time the light source devices are switched, based on the wavelength difference before and after the switching.

In an initial measurement of target sample SMP, focus adjustment is performed manually by the operator or using an autofocus function because the thickness of the sample is unknown. Then, when the light source device to be used is switched, CPU 201 of controller 200 refers to the information stored in storage device 202, and drives stage 150 based on the difference in reference correction value between the light source devices before and after the switching. Such control automatically adjusts the focus to a focal position suitable for the light source device to be used. The user can set whether to enable (ON) or disable (OFF) the auto-correction function of the focus adjustment by setting a hardware switch or a software switch on a display screen.

If the coordinate of stage 150 displayed on display device 220 is changed when the position of stage 150 is automatically adjusted by the focus correction control, the user may mistakenly believe that the focal position has been displaced due to his/her own incorrect operation. For this reason, when the focus correction control is performed, it is preferable to not reflect the focus correction control in the display of the stage position on display device 220, and to not change the display coordinate of stage 150.

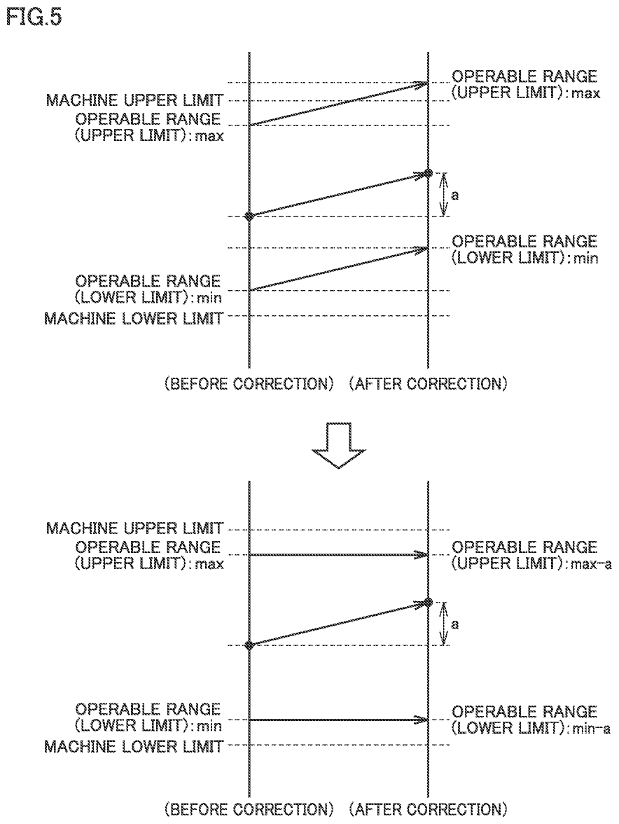

On the other hand, when the display position of stage 150 is different from its actual position, and stage 150 is operated based on the display position, a displayed operable range of stage 150 may exceed a mechanical operable range, as shown in the upper part in FIG. 5. For example, when the focal position is corrected by amount of correction a in the positive direction along the Z-axis (a direction in which a machine is raised) as shown in FIG. 3, the operable range on the upper limit side may exceed the machine upper limit. For this reason, as shown in the lower part in FIG. 5, when the position of stage 150 is changed by amount of correction “a” by the focus correction control, the operable range is changed in accordance with amount of correction “a”. Specifically, an upper limit value max of the operable range is changed to (max-a), and a lower limit value min thereof is changed to (min-a). Thus, when the user manually raises and lowers stage 150 after the focus correction control is performed, movement beyond the mechanical operable range can be suppressed to prevent mechanical damage.

The change of the display of the coordinate of stage 150 associated with the focus correction control as described above is preferably automatically reset when the sample to be measured is changed and/or when focus adjustment is performed manually or using the autofocus function. Alternatively, it may be reset by an operation from the user.

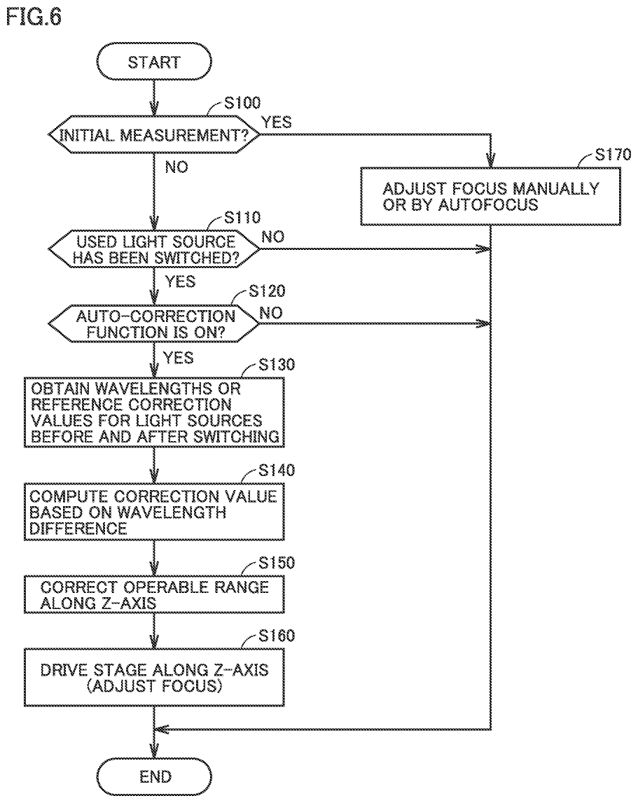

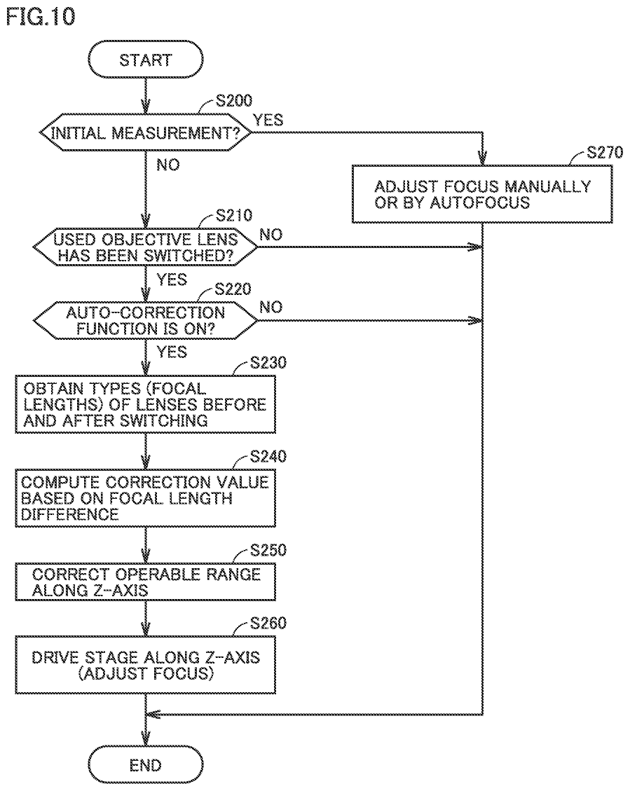

FIG. 6 is a flowchart showing details of the focus correction control in the first embodiment. In one example, the flowcharts shown in FIG. 6 and FIG. 10 which will be described later are implemented when CPU 201 executes a program stored in storage device 202 of controller 200. Some or all of the processing in the flowcharts may be implemented by hardware circuitry in controller 200.

Referring to FIG. 6, in step (the “step” is hereinafter abbreviated as S) 100, controller 200 determines whether or not this is an initial measurement of sample SMP to be measured. When this is the initial measurement (YES in S100), the processing is moved to S170 because focus adjustment of objective lens unit 140 for sample SMP has not been performed, and controller 200 performs focus adjustment of objective lens unit 140 using an existing autofocus function. Alternatively, controller 200 outputs, to display device 220, a display that prompts the user to manually perform focus adjustment.

When this is not the initial measurement, that is, when the focus adjustment for sample SMP to be measured has been performed (NO in S100), controller 200 moves the processing to S110 and determines whether or not a light source device to be used has been switched. The switching of the light source may be detected based on an input to input device 210 from the user, or may be automatically detected based on ON/OFF of the light source device or opening/closing of the shutter.

When the light source has not been switched (NO in S110), the subsequent processing is skipped, and the measurement is continued while the current settings are maintained. When the light source has been switched (YES in S110), the processing is moved to S120 and controller 200 determines whether or not the automatic focus correction function is enabled.

When the auto-correction function is disabled (NO in S120), the subsequent processing is skipped. In this case, focus adjustment is manually performed by the user. When the auto-correction function is enabled (YES in S120), the processing is moved to S130, and controller 200 reads the information stored in storage device 202 (FIG. 4) and obtains the wavelengths and/or the reference correction values for the light source devices before and after the switching. Then, in S140, controller 200 uses the obtained information to determine, by computation, a correction value based on the wavelength difference between the light source devices before and after the switching. Furthermore, in S150, controller 200 corrects the operable range of stage 150 in the Z-axis direction, as described in FIG. 5. Then, in S160, controller 200 drives stage 150 along the Z-axis based on the calculated correction value to perform focus adjustment.

By performing control in accordance with the processing as described above, focus adjustment can be automatically performed in accordance with a light source device to be used, in a micro-Raman apparatus including a plurality of light source devices. Thus, a workload of an operator and a work time can be reduced, and variations in measurement results can be reduced, as compared to when the focus adjustment is manually performed.

The “visible light source 111” in the first embodiment corresponds to a “first light source device” in the present disclosure. The “laser light source 112” and the “laser light source 113” in the first embodiment correspond to a “second light source device” and a “third light source device” in the present disclosure, respectively. The “infrared light source 114” in the first embodiment corresponds to a “fourth light source device” in the present disclosure.

### Second Embodiment

In the configuration described in the first embodiment, when a light source device to be used is switched, focus adjustment is automatically performed in accordance with a wavelength of light from each light source device.

A micro-Raman apparatus may be provided with a plurality of objective lenses in order to change the magnification of a measurement region of a sample to be measured. Even when the same light source device is used, switching of the objective lenses requires performing another focus adjustment because the objective lenses that are used have different sizes and focal lengths.

In a configuration described in a second embodiment, focus adjustment is automatically performed in accordance with an objective lens used for measurement, in a micro-Raman apparatus provided with a plurality of objective lenses.

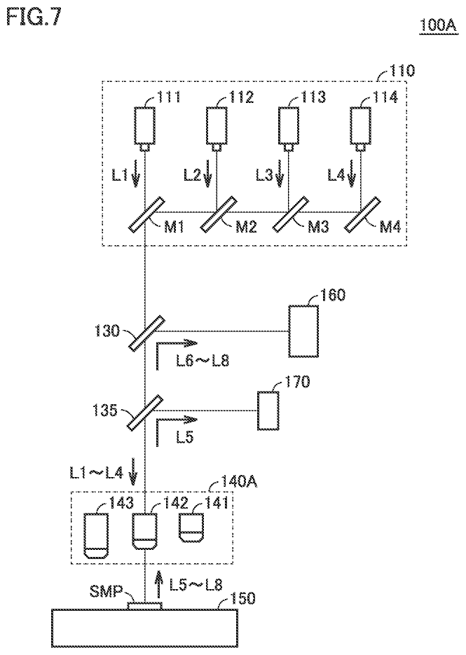

FIG. 7 is a diagram showing the configuration of a micro-Raman apparatus 100A in the second embodiment. In micro-Raman apparatus 100A, objective lens unit 140 in micro-Raman apparatus 100 described in FIG. 2 is replaced with an objective lens unit 140A. In FIG. 7, the description of the same elements as those in FIG. 2 will not be repeated.

Referring to FIG. 7, objective lens unit 140A of micro-Raman apparatus 100A includes objective lenses 141 to 143 of different focal lengths from one another. Objective lenses 141 to 143 are attached to a rotating or sliding holder (not shown), and moving the holder allows for switching to a desired objective lens.

Generally, the focal length of an objective lens increases as the magnification increases. Therefore, even after focus adjustment is completed with one objective lens, switching to another objective lens results in a changed focal position.

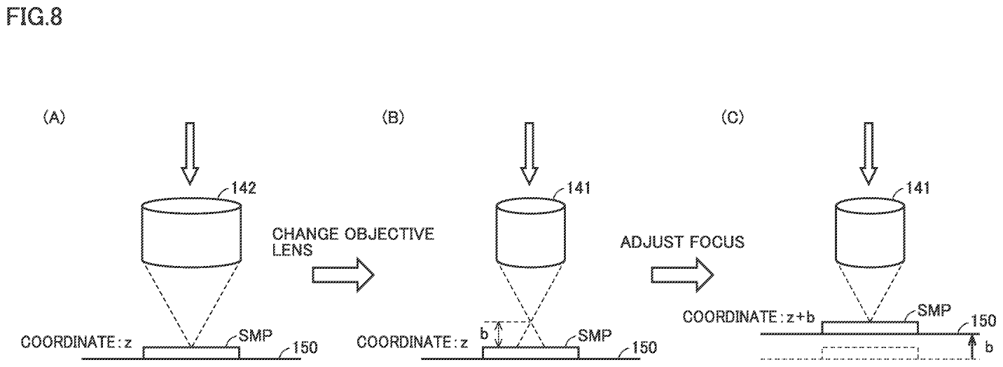

For example, after focus adjustment is completed with objective lens 142 as shown in the left diagram (A) in FIG. 8, switching to objective lens 141 of a shorter focal length than objective lens 142 (the middle diagram (B)) causes the light collection position to change from a position on sample SMP in the left diagram (A) to a position above and distant from this position by “b”. Conversely, switching to objective lens 143 of a longer focal length than objective lens 142 causes the light collection position to change to a position below the position on sample SMP.

Since the specifications of the focal positions of the objective lenses are known in advance, focus adjustment can be automatically performed as shown in the right diagram (C) in FIG. 8, by storing the difference in focal position between objective lenses to be used in storage device 202 as a correction value, and by moving stage 150 in accordance with the correction value when the objective lenses are switched.

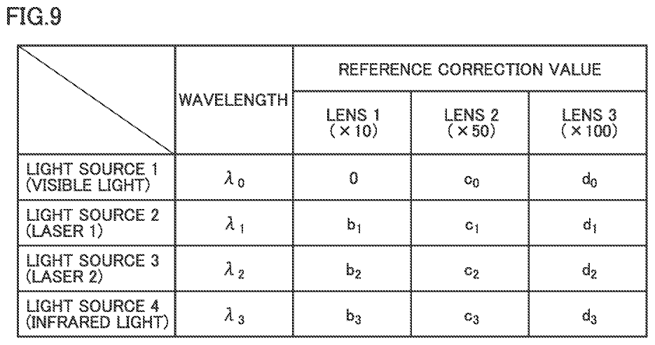

FIG. 9 is a diagram showing an example of information stored in storage device 202 in the second embodiment. In the example of FIG. 9, the information includes a wavelength of light emitted from each light source device, and a reference correction value corresponding to each objective lens. The reference correction value is set as a correction value that takes into account the amount of displacement of the focal length when the objective lenses are switched and the amount of displacement when the light source devices are switched, with the focal position when using objective lens 141 (lens 1) of the shortest focal position in visible light source 111 being used as a reference (correction value=0). Controller 200 can automatically perform focus correction control using the correction values shown in FIG. 9.

In the second embodiment as well, the display of the stage position is maintained during the focus correction control, and the operable range is corrected, as in the first embodiment. Since the size (length in the optical axis direction) of the objective lens changes with the magnification as described above, it is preferable to set the operable range by taking into account the size of the objective lens as well, when correcting the operable range. The higher the magnification, the larger the lens size, and therefore, the higher the likelihood of sample SMP and the objective lens making contact with each other. Therefore, it is necessary to set the lower limit of the operable range, in particular, by taking into account the lens size in addition to the difference in focal length.

FIG. 10 is a flowchart showing details of the focus correction control in the second embodiment. The flowchart of FIG. 10 describes an example of switching only an objective lens without switching a light source device to be used.

Referring to FIG. 10, in S200, controller 200 determines whether or not this is an initial measurement of sample SMP to be measured. When this is the initial measurement (YES in S200), the processing is moved to S270 because focus adjustment of objective lens unit 140A for sample SMP has not been performed. Controller 200 performs focus adjustment of objective lens unit 140A using an existing autofocus function. Alternatively, controller 200 outputs, to display device 220, a display that prompts the user to manually perform focus adjustment.

When this is not the initial measurement, that is, when the focus adjustment for sample SMP to be measured has been performed (NO in S200), controller 200 moves the processing to S210 and determines whether or not an objective lens to be used has been switched.

When the objective lens has not been switched (NO in S210), the subsequent processing is skipped, and the measurement is continued while the current settings are maintained. When the objective lens has been switched (YES in S210), the processing is moved to S220 and controller 200 determines whether or not the automatic focus correction function is enabled.

When the auto-correction function is disabled (NO in S220), the subsequent processing is skipped. In this case, focus adjustment is manually performed by the user. When the auto-correction function is enabled (YES in S220), the processing is moved to S230, and controller 200 reads the information stored in storage device 202 (FIG. 9) and obtains reference correction values corresponding to the types (focal lengths) of the objective lenses before and after the switching. Then, in S240, controller 200 uses the obtained information to determine, by computation, a correction value based on the focal length difference between the objective lenses before and after the switching.

Furthermore, in S250, controller 200 corrects the operable range of stage 150 in the Z-axis direction. At this time, the operable range is set that takes into account the size of the objective lens in addition to the correction value based on the focal length. Then, in S260, controller 200 drives stage 150 along the Z-axis based on the calculated correction value to perform focus adjustment.

Even when the light source device is switched in addition to the objective lens, focus adjustment can be performed in accordance with the wavelength of light emitted from the light source device and the type of the objective lens, using the correction values shown in FIG. 9.

By performing control in accordance with the processing as described above, focus adjustment can be automatically performed in accordance with an objective lens to be used, in a micro-Raman apparatus including a plurality of objective lenses. Thus, a workload of an operator and a work time can be reduced, and variations in measurement results can be reduced, as compared to when the focus adjustment is manually performed.

### Aspects

It will be understood by those skilled in the art that the plurality of exemplary embodiments described above are specific examples of aspects below.
(Clause 1) A micro-Raman apparatus according to an aspect includes a light source unit, an objective lens unit, a detection device, a drive device, and a controller for controlling the drive device. The light source unit includes a plurality of light source devices configured to emit lights of different wavelengths from one another.

The objective lens unit collects light from the light source unit and irradiates a sample to be analyzed with the light. The detection device detects Raman-scattered light emitted from the sample. The drive device changes a relative distance between the sample and the objective lens unit. The controller is configured to correct the relative distance in accordance with a wavelength of light emitted from a light source device to be used.

In the micro-Raman apparatus according to clause 1, the relative distance between the objective lens and the sample is corrected in accordance with a wavelength of a light source device to be used, in a configuration including the plurality of light source devices. That is, when the light source devices are switched, focus adjustment is automatically performed in accordance with the difference in wavelength between the light sources before and after the switching. Therefore, focus adjustment associated with switching of light sources can be facilitated, and variations in measurement results can be reduced, in the micro-Raman apparatus including the plurality of light source devices.
(Clause 2) In the micro-Raman apparatus according to clause 1, the controller includes a processor, and a storage device having stored thereon, for each of the plurality of light source devices, a correction value from a reference distance between the sample and the objective lens unit. The processor is configured to obtain, from the storage device, a correction value corresponding to a light source device to be used, and corrects the relative distance.

In the micro-Raman apparatus according to clause 2, the processor of the controller can perform focus adjustment based on a correction value stored in the storage device. Therefore, focus adjustment associated with switching of light sources can be facilitated, and variations in measurement results can be reduced.
(Clause 3) In the micro-Raman apparatus according to clause 1, the controller includes a processor, and a storage device having stored thereon information about a wavelength of each of the plurality of light source devices.

When a light source device to be used is changed, the processor is configured to obtain, from the storage device, wavelengths of light source devices before and after the change, and corrects the relative distance in accordance with a relative difference in wavelength between the light source devices.

In the micro-Raman apparatus according to clause 3, the processor can perform focus adjustment based on information about the wavelength of each light source device stored in the storage device. Therefore, focus adjustment associated with switching of light sources can be facilitated, and variations in measurement results can be reduced.
(Clause 4) In the micro-Raman apparatus according to any one of clauses 1 to 3, the plurality of light source devices include a first light source device that emits visible light, and a second light source device that emits laser light of a first wavelength.

In the micro-Raman apparatus according to clause 4, a focus shift between the visible light source and the laser light source can be automatically adjusted.
(Clause 5) In the micro-Raman apparatus according to clause 4, the plurality of light source devices further include a third light source device that emits laser light of a second wavelength different from the first wavelength.

In the micro-Raman apparatus according to clause 5, a focus shift between the visible light source and the two laser light sources of different wavelengths can be automatically adjusted.
(Clause 6) In the micro-Raman apparatus according to clause 4 or 5, the plurality of light source devices further include a fourth light source device that emits infrared light.

In the micro-Raman apparatus according to clause 6, when using the infrared light source, a focus shift between the infrared light source and the visible light source and/or the laser light source can be automatically adjusted.
(Clause 7) In the micro-Raman apparatus according to any one of clauses 1 to 3, the plurality of light source devices include a second light source device that emits laser light of a first wavelength, and a third light source device that emits laser light of a second wavelength different from the first wavelength.

In the micro-Raman apparatus according to clause 7, a focus shift between the two laser light sources of different wavelengths can be automatically adjusted.
(Clause 8) The micro-Raman apparatus according to any one of clauses 1 to 7 further includes a stage on which the sample is placed. The drive device is configured to drive the stage to change the relative distance.

In the micro-Raman apparatus according to clause 8, the controller can perform focus adjustment by moving the stage on which the sample is placed by the drive device.
(Clause 9) The micro-Raman apparatus according to clause 8 further includes a display device for displaying a position of the stage. Even when the relative distance is corrected due to a change of a light source device to be used, the controller does not reflect the correction in a display of the position of the stage on the display device.

In the micro-Raman apparatus according to clause 9, even when focus adjustment is automatically performed due to switching of the light source devices, the display of the stage position on the display device is not changed. This can prevent the user from mistakenly believing that he/she has performed an incorrect operation.
(Clause 10) In the micro-Raman apparatus according to any one of clauses 1 to 9, the controller is configured to set whether or not to perform the correction of the relative distance in accordance with a light source device to be used.

In the micro-Raman apparatus according to clause 10, the user can set whether or not to perform the automatic focus adjustment associated with switching of light source devices. Thus, when there is a possible risk such as a collision of the objective lens and the sample when performing the automatic focus adjustment, such risk can be prevented.
(Clause 11) In the micro-Raman apparatus according to any one of clauses 1 to 10, the objective lens unit includes a plurality of objective lenses having different focal lengths from one another. The controller is configured to correct the relative distance in accordance with an objective lens to be used.

In the micro-Raman apparatus according to clause 11, focus adjustment can be automatically performed in accordance with an objective lens, in a configuration including the plurality of objective lenses. Therefore, focus adjustment associated with switching of objective lenses can be facilitated, and variations in measurement results can be reduced, in the micro-Raman apparatus including the plurality of objective lenses.
(Clause 12) A method for controlling a micro-Raman apparatus according to another aspect relates to a method for controlling a micro-Raman apparatus including a light source unit, an objective lens unit, a detection device, and a drive device. The light source unit includes a plurality of light source devices configured to emit lights of different wavelengths from one another. The objective lens unit is configured to collect light from the light source unit and irradiate a sample to be analyzed with the light. The detection device is configured to detect Raman-scattered light emitted from the sample. The drive device is configured to change a relative distance between the sample and the objective lens unit. The method includes: (a) obtaining information about the plurality of light source devices; (b) computing a correction value of the relative distance in accordance with a wavelength of light emitted from a light source device to be used; and (c) driving the drive device based on the correction value to change the relative distance.

In the method for controlling a micro-Raman apparatus according to clause 12, the relative distance between the objective lens and the sample is corrected in accordance with a wavelength of a light source device to be used, in a configuration including the plurality of light source devices. That is, when the light source devices are switched, focus adjustment is automatically performed in accordance with the difference in wavelength between the light sources before and after the switching. Therefore, focus adjustment associated with switching of light sources can be facilitated, and variations in measurement results can be reduced, in the micro-Raman apparatus including the plurality of light source devices.

It should be understood that the embodiments disclosed herein are illustrative and non-restrictive in every respect. The scope of the present invention is defined by the terms of the claims, rather than the description of the embodiments above, and is intended to include any modifications within the meaning and scope equivalent to the terms of the claims.

### REFERENCE SIGNS LIST

100, 100A micro-Raman apparatus; 110 light source unit; 111 visible light source; 112, 113 laser light source; 114 infrared light source; 120 collimator lens; 130, 135 beam splitter; 140, 140A objective lens unit; 141 to 143 objective lens; 150 stage; 180 drive device; 160 detection device; 162 filter; 164, 175 condenser lens; 166 slit; 167 light collection point; 170 imaging device; 200 controller; 201 CPU; 202 storage device; 210 input device; 220 display device; M1 to M4 mirror; SMP sample.

1. A micro-Raman apparatus comprising:
a light source unit including a plurality of light source devices configured to emit lights of different wavelengths from one another;
an objective lens unit that collects light from the light source unit and irradiates a sample to be analyzed with the light;
a detection device that detects Raman-scattered light emitted from the sample;
a drive device that changes a relative distance between the sample and the objective lens unit; and
a controller that controls the drive device, wherein
the controller is configured to correct the relative distance in accordance with a wavelength of light emitted from a light source device to be used,
the light source unit is configured to switch a light source device to be used among the plurality of light source devices,
the controller includes
a processor, and
a storage device having stored thereon, for each of the plurality of light source devices, a correction value from a reference distance between the sample and the objective lens unit, and
the processor is configured to obtain, from the storage device, a correction value corresponding to a light source device to be used, and correct the relative distance using the obtained correction value.

2. A micro-Raman apparatus comprising:
a light source unit including a plurality of light source devices configured to emit lights of different wavelengths from one another;
an objective lens unit that collects light from the light source unit and irradiates a sample to be analyzed with the light;
a detection device that detects Raman-scattered light emitted from the sample;
a drive device that changes a relative distance between the sample and the objective lens unit; and
a controller that controls the drive device, wherein
the controller is configured to correct the relative distance in accordance with a wavelength of light emitted from a light source device to be used,
the light source unit is configured to switch a light source device to be used among the plurality of light source devices,
the controller includes
a processor, and
a storage device having stored thereon information about a wavelength of each of the plurality of light source devices, and
when a light source device to be used is changed, the processor is configured to obtain, from the storage device, wavelengths of light source devices before and after the change, and correct the relative distance in accordance with a relative difference in wavelength between the light source devices before and after the change.

3. The micro-Raman apparatus according to claim 1, wherein
the plurality of light source devices include
a first light source device that emits visible light, and
a second light source device that emits laser light of a first wavelength.

4. The micro-Raman apparatus according to claim 3,
wherein
the plurality of light source devices further include a third light source device that emits laser light of a second wavelength different from the first wavelength.

5. The micro-Raman apparatus according to claim 3,
wherein
the plurality of light source devices further include a fourth light source device that emits infrared light.

6. The micro-Raman apparatus according to claim 1, wherein
the plurality of light source devices include
a second light source device that emits laser light of a first wavelength, and
a third light source device that emits laser light of a second wavelength different from the first wavelength.

7. The micro-Raman apparatus according to claim 1, further comprising a stage on which the sample is placed, wherein
the drive device is configured to drive the stage to change the relative distance.

8. The micro-Raman apparatus according to claim 7, further comprising a display device for displaying a position of the stage, wherein
even when the relative distance is corrected due to a change of a light source device to be used, the controller does not reflect the correction in a display of the position of the stage on the display device.

9. The micro-Raman apparatus according to claim 1, wherein
the controller is configured to be able to set whether or not to perform the correction of the relative distance in accordance with a light source device to be used.

10. The micro-Raman apparatus according to claim 1, wherein
the objective lens unit includes a plurality of objective lenses having different focal lengths from one another, and
the controller is configured to correct the relative distance in accordance with an objective lens to be used.

11. A method for controlling a micro-Raman apparatus,
the micro-Raman apparatus including
a light source unit including a plurality of light source devices configured to emit lights of different wavelengths from one another,
an objective lens unit that collects light from the light source unit and irradiates a sample to be analyzed with the light,
a detection device that detects Raman-scattered light emitted from the sample,
a drive device that changes a relative distance between the sample and the objective lens unit, and
a storage device having stored thereon, for each of the plurality of light source devices, a correction value from a reference distance between the sample and the objective lens unit, wherein
the light source unit is configured to switch a light source device to be used among the plurality of light source devices,
the method comprising:
obtaining information about the plurality of light source devices;
obtaining, from the storage device, the correction value corresponding to a light source device to be used; and
driving the drive device based on the obtained correction value to change the relative distance.

12. A method for controlling a micro-Raman apparatus,
the micro-Raman apparatus including
a light source unit including a plurality of light source devices configured to emit lights of different wavelengths from one another,
an objective lens unit that collects light from the light source unit and irradiates a sample to be analyzed with the light,
a detection device that detects Raman-scattered light emitted from the sample,
a drive device that changes a relative distance between the sample and the objective lens unit, and
a storage device having stored thereon information about a wavelength of each of the plurality of light source devices,
the method comprising:
obtaining information about the plurality of light source devices;
when a light source device to be used is changed, obtaining, from the storage device, wavelengths of light source devices before and after the change; and
driving the drive device in accordance with a relative difference in wavelength between the light source devices before and after the change to change the relative distance.
